(19) United States
(12) Patent Application Publication
(10) Pub. No.: US 2026/0205425 A1
(43) Pub. Date: Jul. 16, 2026

(54) Bandwidth Utilization Improvement in Interconnect Fabric Physical Die Crossing

(71) Applicant: Tenstorrent USA, Inc., Austin, TX (US)

(72) Inventor: Tejpal Singh, Shrewsbury, MA (US)

(21) Appl. No.: 19/024,227

(22) Filed: Jan. 16, 2025

(51) Int. Cl. H04L 49/50; H04L 49/109; H04L 49/25

(52) U.S. Cl. CPC H04L 49/50; H04L 49/109; H04L 49/25

(57) ABSTRACT

Systems and methods related to bandwidth utilization improvements in interconnect fabric physical die crossings are disclosed herein. One or more message may be send from a first die to a second die using an interconnect fabric link. The first die may determine that the size of a message is smaller than a threshold and compress the message based on the determining. The first die may send the message from the first die to the second die, the first die being physically separate from the second die and the first die sharing an interconnect fabric with the second die. The first die may compress a second message and may send the message and the second message together in a packet. The packet can have a size equal to a bandwidth of the interconnect fabric link. Sending the messages together may reduce overhead, reduce latency, and improve efficiency for inter-die messaging.

### BACKGROUND

Historically, integrated circuits (ICs) were implemented on single monolithic dies. However, as transistor counts and complexity increased, monolithic dies faced yield issues, thermal challenges, scaling limits, and other issues. To address these issues, multi-die systems and chiplet-based designs were introduced, requiring efficient inter-die crossing mechanisms. Inter-die crossing refers to the process of enabling communication between different physical dies in a multi-die or chiplet-based architecture. As semiconductor technology evolves, inter-die crossing has become critical for scaling performance, reducing costs, and addressing manufacturing and design challenges associated with monolithic dies. Inter-die crossing mechanisms aim to enable high-bandwidth and low-latency communication between dies, minimize power consumption, maintain or improve signal integrity over the physical distance between dies, and ensure scalability to allow more dies to be interconnected. Physical interconnects include trace lines on multi-die substrates, solder bumps, lead frames, silicon interposers, through-silicon vias, and advanced packaging technologies.

Inter-die communication allows the exchange of data between different physical die in a multi-die or chiplet-based system. Unlike traditional monolithic chips, which integrate all components on a single die, multi-die systems break functionality across multiple dies to enhance manufacturing yield, modularity, and performance. However, this architecture introduces unique challenges. For example, bandwidth and latency constraints arise, particularly in high-performance systems where large volumes of data must be transmitted rapidly. High bandwidth is needed to handle the massive data exchange between dies, especially in high-performance systems like AI accelerators. Low latency is crucial for applications such as cache coherency in multi-core processors.

Inter-die communication can create a significant bottleneck in multi-die systems, as the data transfer between physically separate dies is inherently slower and less efficient than intra-die communication. Unlike components on a single die, which benefit from high-bandwidth, low-latency pathways, inter-die links face limitations in signaling speed, power consumption, and bandwidth density. The physical separation between dies introduces latency due to longer transmission paths and the need for repeaters or serialization/deserialization processes. Additionally, inter-die connections consume more power and are more prone to signal degradation, resulting in reduced throughput and reliability. As data-intensive applications such as AI and high-performance computing demand ever-increasing bandwidth, the mismatch between the capabilities of inter-die and intra-die communication can throttle overall system performance, making the inter-die links a critical bottleneck.

### SUMMARY

Systems and methods related to bandwidth utilization improvement in interconnect fabric physical die crossing are disclosed herein. One or more messages may be sent from a first die to a second die using an interconnect fabric link. The first die may be physically separate from the second die. The first die may determine that a size of a first message is smaller than or equal to a threshold and may compress the first message based on this determination. The first die may determine that a size of a second message is smaller than or equal to a threshold and may compress the second message based on this determination. The first die may compress the first message and the second message into a packet. The packet may have a size that is equal to a bandwidth of the interconnect fabric link.

As the term is used herein, the “bandwidth” refers to the physical width of a network link. For example, an interconnect fabric link that has a number of wires sufficient to physically transport 16 bytes of data in parallel has a bandwidth of 16 bytes. The size of the packet that is equal to this bandwidth is set by the physical layer protocol of the interconnect fabric. Accordingly, any discussions herein regarding compressing multiple messages into a packet are also applicable to compressing multiple messages into whatever data structure or physical hardware supports the parallel movement of data through a physical die-to-die crossing. Compressing multiple messages into a packet can therefore also be considered as compressing multiple messages into the bandwidth of the physical die-to-die crossing.

In accordance with specific embodiments of the inventions disclosed herein, die-to-die bandwidth may be improved by enabling traffic-aware compression of packets on die crossing at the physical layer. The compression is traffic-aware in that the compression is based off a determination of the size of individual messages being sent through the die-to-die crossings. As used herein, the term “compressing” when used with reference to messages refers to putting a given number of messages in fewer packets (e.g., putting several small messages into a single packet). n specific examples, the messages themselves are also “compressed” in the sense of a different encoding being applied to represent the underlying data so fewer bits are used to represent the original data. Indeed, compressing and sending small messages together in single packets across die-to-die crossings can be conducted using slight modifications to circuitry that is already available in standard die-to-die interfaces which is used to encode messages in a compressed format before it is transmitted. As such, in specific embodiments of the invention, improved performance may be achieved without significant additional hardware costs.

Compressing and sending small messages together may reduce overhead compared to sending the messages separately and may generally improve power consumption and performance without significant increase in die size or interconnect fabric size. For example, a message (e.g., a 128-byte flit) that is to be transferred between two dies using a physical layer protocol with a bandwidth of 256 bytes may be compressed into an individual packet with another message of the same size and result in a 50% reduction in the overhead of the message transfer through the physical link. For smaller packets (e.g., a 32-byte flits sent on an interconnect link with a width of 256 byte), overhead is reduced by more than 50% and further benefits can be realized. In specific embodiments, compressing and transporting small messages together in this manner can be conducted at a partial flit level of granularity to produce even further performance improvements.

In specific embodiments of the invention, a method is provided. The method comprises: determining (at a first die) that a size of a message is smaller than or equal to a threshold, compressing (at the first die) the message based on the determining, and sending the message from the first die to a second die, the first die being physically separate from the second die and the first die sharing an interconnect fabric with the second die.

In specific embodiments of the invention, a system is provided. The system comprises a first die, the first die determining that a size of a first message is smaller than or equal to a first threshold and a size of a second message is smaller than or equal to a second threshold. The system further comprises a compressing circuit, in the first die, that compresses the first message and the second message based on the determining. The system further comprises an interconnect fabric link coupled to the first die and to a second die, the interconnect fabric link transporting the first message and the second message from the first die to the second die, the first message and the second message sharing a packet of the interconnect fabric link. The system further comprises a decompressing circuit, in the second die, that decompresses the first message and the second message based on the compressing circuit compressing the first message and the second message.

In specific embodiments of the invention, a method is provided. The method comprises: determining (at a first die) that a size of a message is equal to or less than a threshold size, compressing (at the first die) the message based on the determination that the size of the message is equal to or less than the threshold size, packetizing (at the first die and after the compressing) the message, serializing (at the first die and after the packetizing) the message, and sending (after the serializing) the message from the first die to a second die via an interconnect fabric link, the interconnect fabric link coupling the first die with the second die. The method further comprises: deserializing (at the second die) the message, depacketizing (at the second die and after the deserializing) the message, and decompressing (at the second die and after the depacketizing) the message.

### BRIEF DESCRIPTION OF THE DRAWINGS

The accompanying drawings illustrate various embodiments of systems, methods, and various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a network of dies in accordance with specific embodiments of the inventions disclosed herein.

FIG. 2 provides an example of a network-on-chip (NoC) flit crossing from a router in one die to a router in another die in accordance with specific embodiments of the inventions disclosed herein.

FIG. 3 provides an example of a system including two dies within an interconnect fabric in accordance with specific embodiments of the inventions disclosed herein.

FIG. 4 provides examples of an interconnect fabric connecting two dies with various messages of differing sizes sent using an interconnect fabric link packet in accordance with specific embodiments of the inventions disclosed herein.

FIG. 5 provides an example of a system with a packet of an interconnect fabric link split evenly between two flits in accordance with specific embodiments of the inventions disclosed herein.

FIG. 6 provides an example of a method for compressing a message if the message size is smaller than or equal to a threshold size in accordance with specific embodiments of the inventions disclosed herein.

FIG. 7 provides an example of a method for compressing three messages if the message sizes are smaller than or equal to respective threshold sizes in accordance with specific embodiments of the inventions disclosed herein.

FIG. 8 provides an example of a method for compressing two messages if the message sizes are smaller than or equal to respective threshold sizes, the two messages being different sizes, in accordance with specific embodiments of the inventions disclosed herein.

FIG. 9 provides an example of a flowchart for compressing a message if the message size is smaller than or equal to a threshold size in accordance with specific embodiments of the inventions disclosed herein.

FIG. 10 provides an example of a method for compressing, packetizing, and serializing a message if the message size is smaller than or equal to a threshold size in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for bandwidth utilization improvements in interconnect fabric physical die crossings in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Inter-die crossing, the process of enabling communication between different physical dies in a multi-die or chiplet-based architecture, is increasingly common in the industry. Die crossings have power, area, and bandwidth overhead, which may be large compared to intra-die communication. As data-intensive applications such as AI and high-performance computing demand ever-increasing bandwidth, the mismatch between the capabilities of inter-die and intra-die communication can throttle overall system performance, making the inter-die links a critical bottleneck.

AI model sizes have grown substantially and performance targets for these models drive higher compute, memory, IO, and bandwidth capabilities. These capabilities, in turn, may drive higher on-die and on-package bandwidth. In some cases, to accommodate this increasing on-die and on-package bandwidth, the bandwidth of Network-on-Chip (NoC) connections has increased, which may cause increased wire count in NoCs (e.g., from 32 byte to 256 byte wide). However, not all messages that cross dies may use the entire NoC bandwidth, resulting in reduced efficiency (e.g., bandwidth underutilization). AI may require high bandwidth data movement in a socket. This, in turn, may require a wide NoC. For small data packets, wide NoCs are inefficient in bandwidth per wire and bandwidth per area. The inefficiency cost for die crossing are even higher compared to inefficiency costs for on chip NoC wires due to the longer distances the data must travel and the commensurate impact on latency and power consumption. To improve die crossing efficiency, the physical layer may be increased in size (e.g., add more and larger wires connecting dies), which may increase die area and product cost. As an alternative, die crossing efficiency may be improved by reducing bandwidth underutilization by compressing and sending multiple small messages together in a single packet. This method may refrain from adding additional hardware, may allow high bandwidth applications, and may efficiently use available bandwidth.

Compressing and sending small messages together may improve effective bandwidth utilization through existing physical layers. Therefore, improved performance may be achieved without additional hardware and software costs. Additionally, compressing and transporting small messages together may reduce the overhead compared to sending the messages separately, and may generally improve power consumption and performance without significant increase in die size or interconnect fabric size. Using the approaches disclosed herein, the size of a message can be determined by circuitry at the inter-die crossing and the message can be compressed if the size if below a threshold. The message can be compressed into a packet with other messages that have been evaluated by the circuitry. The size of the packet can be set by a physical layer protocol of the interconnect fabric link. The size of the packet can be the bandwidth of the inter-die crossing. For example, if the inter-die crossing had enough wires to transport 16 bytes in parallel, the packet would be a 16 byte packet.

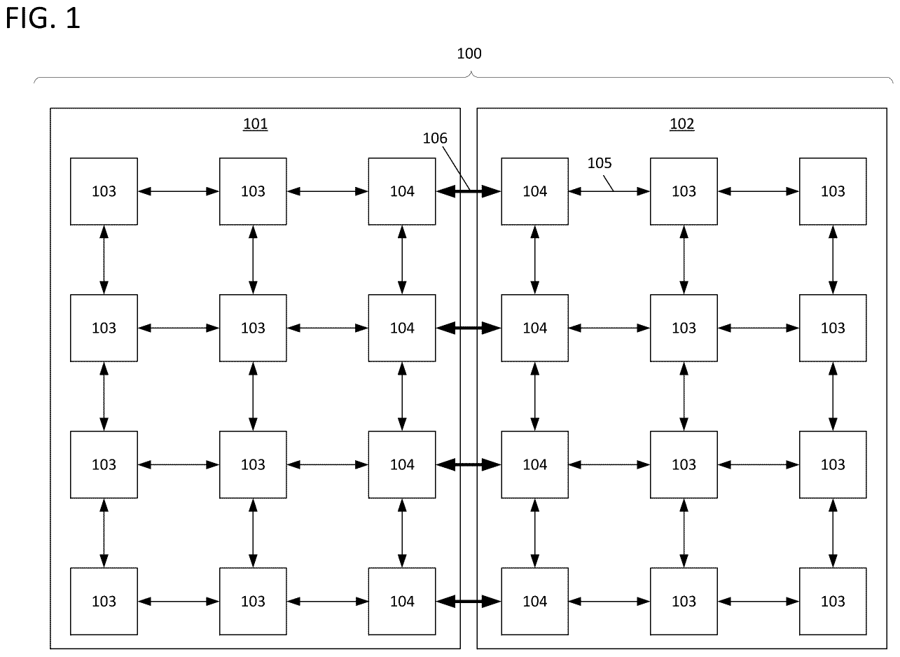

FIG. 1 illustrates an example of network 100 including die 101 and die 102 in accordance with specific embodiments of the inventions disclosed herein. Each die includes multiple routers. Routers 103 only communicate via intra-die paths 105 and routers 104 communicate via both intra-die paths 105 and inter-die paths 106 (e.g., die crossings). Routers 103 and 104 may be Network-on-chip (NoC) routers. Die 101 and die 102 may operate using different NoCs or the same NoC. Die 101 and die 102 may be physically separate dies connected on the same interconnect fabric. Inter-die paths 106 may also be referred to as interconnect fabric links. Routers 103 may be independently associated with separate nodes that are networked together using the interconnect fabric. The nodes can be computational nodes that are coherently linked by the interconnect fabric to execute a complex computation using a shared memory space.

The bandwidth per area ratio and bandwidth per power ratio of intra-die paths 105 may be higher than the bandwidth per area ratio and bandwidth per power ratio of inter-die paths 106 due to area and cost constraints of inter-die paths 106. This inequality may lead to bandwidth bottlenecks at inter-die paths 106, as inter-die paths 106 may be a bandwidth constraint point. To achieve high performance for certain workloads (e.g., large language model (LLM) workloads) of network 100, performance of inter-die paths 106 may be improved relative to intra-die path 105 (e.g., multiple dies to appear as close to monolithic as possible). Improving inter-die path performance (e.g., improving effective bandwidth) may directly improve overall network 100 performance.

To improve die crossing efficiency, the physical layer may be increased in size (e.g., add more wires connecting dies), which may increase die area and product cost. Giving higher area to die crossing may take area way from compute applications; if the logic used for handling die-to-die communications is made larger, there may be less room on the chip for computational core hardware. Furthermore, in specific implementations there is only so much room at the edge of each die to be split amongst the different inter-die paths that utilize a given edge. As such, increasing the size of each inter-die path can reduce the number of inter-die paths that can be supported for a given edge. As an alternative, die crossing efficiency may be improved by reducing bandwidth underutilization. However, reducing bandwidth size may decrease performance for AI workloads and increase software programming complexity. Another alternative for improving inter-die efficiency could be reducing bandwidth underutilization by compressing multiple messages into a single packet. This method may refrain from adding additional hardware, may allow high bandwidth applications, and may efficiently use available bandwidth.

One or more messages may be sent from die 101 to die 102 using an inter-die path 106 (e.g., an interconnect fabric link). Die 101 may determine that a size of a first message is smaller than or equal to a threshold and may compress the first message based on this determination. Die 101 may determine that a size of a message is larger than a threshold and may not compress the message based on that determination. Die 101 may determine that a size of a second message is smaller than or equal to a threshold and may compress the second message based on this determination. Die 101 may send the first message and the second message from a router 104 of die 101 to a router 104 of die 102. Die 101 may send the first message and the second message within a single packet of the physical layer protocol for the inter-die path 106. The size of the single packet may be equal to the bandwidth of inter-die path 106.

Compressing and sending small messages together to share a packet may improve effective bandwidth utilization through existing physical layers. Therefore, improved performance may be achieved without additional hardware and software costs. Additionally, compressing and sending the small messages together may reduce the overhead compared to sending the messages separately, and may generally improve power consumption and performance without significant increase in die size or interconnect fabric size.

As used herein the term “interconnect fabric” refers to a hardware and software infrastructure that enables the efficient transfer of data between nodes within a computing system. It facilitates communication by connecting the computational nodes (e.g., processors, accelerators, or memory subsystems) and enabling data exchange within a common address space. This common address space allows nodes to reference and access data consistently, regardless of their physical location. In systems with a shared memory architecture, the interconnect fabric facilitates seamless access to shared memory resources. This allows multiple computational nodes to read from and write to the same memory locations, enabling cooperative processing and data sharing. An interconnect fabric acts as the communication backbone in a computational system, such as those using a network on chip, providing the mechanisms for data exchange, synchronization, and shared memory access across a distributed architecture with a unified address space. Interconnect fabrics also include hardware-level integration that directly facilitates data exchange between nodes, often with specialized routing, arbitration, and buffering mechanisms. A NoC is an example of an interconnect fabric.

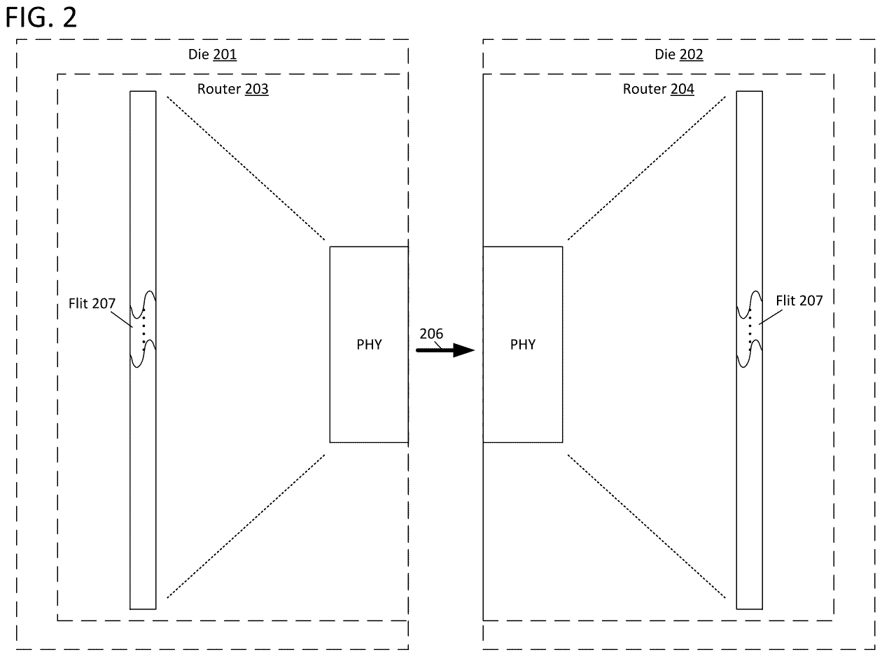

FIG. 2 illustrates an example of NoC flit 207 crossing from router 203 in die 201 to router 204 in die 202 in accordance with specific embodiments of the inventions disclosed herein. Die 201 may compress, packetize, and serialize flit 207 from the NoC layer to the physical layer (PHY). Flit 207 may cross from router 203 to router 204 using interconnect fabric link 206. Die 202 may deserialize, depacketize, and decompress flit 207 from the physical layer (PHY) to the NoC layer. Router 203 and router 204 may be similar to router 104. Interconnect fabric link 206 may be similar to inter-die path 106.

Die 201 may determine (e.g., at router 203) that the size of NoC flit 207 is equal to or smaller than a threshold size. The NoC header portion of NoC flit 207 may have information about the packet size of NoC flit 207. The NoC header portion of NoC flit 207 may be decoded to determine the packet size of NoC flit 207. If the size of NoC flit 207 is equal to or smaller than the threshold size, then die 201 (e.g., at router 203) may compress flit 207. Die 201 may flag flit 207 as being compressed (e.g., may add two bits to flit 207 indicating whether or not flit 207 is compressed). Die 201 may also packetize and serialize flit 207 (e.g., at router 203) from the NoC layer to the physical layer (PHY). Flit 207 may cross from router 203 to router 204 using interconnect fabric link 206 and may share a packet of interconnect fabric link 206 with another compressed flit. The packet can have a size equal to the bandwidth of interconnect fabric link 206. Die 202 (e.g., at router 204) may deserialize and depacketize flit 207 from the PHY to the NoC layer. If die 201 compressed flit 207, then die 202 may decompress flit 207 (e.g., at router 204). Packetization and serialization at die crossings already incur latency. Accordingly, collocating logic to evaluate, compress, and decompress flit 207 in accordance with the approaches disclosed herein achieves bandwidth utilization improvements with little to no additional latency cost. In specific embodiments, the logic used to evaluate the flits to determine if they should be compressed or not is logic that is already used to obtain data from the headers of the flits for evaluation such that even less overhead is required to implement some of the approaches disclosed herein as compared to prior art approaches.

Flit 207 may cross from router 203 to router 204 using interconnect fabric link 206 and may share a packet of interconnect fabric link 206 with another compressed flit. The other compressed flit may also be equal to or smaller than the threshold size or may be equal to or smaller than a different threshold size. As used in this context, the term “packet” refers to a set of data that is sent in parallel on interconnect fabric link 206. While specific sizes are provided as examples herein nothing in this disclosure should be read to limit the size of the packets or the number of messages that can be compressed into a single packet. The thresholds may be based on the bandwidth of interconnect fabric link 206 and the sizes of compressed or uncompressed messages. Interconnect fabric link 206 may be a high-speed communication pathway within a fabric interconnect architecture and may be designed to connect components such as processors, memory, storage, and peripherals within the system. An interconnect fabric may refer to a network-like structure that provides pathways for data to flow between multiple devices or components. The interconnect fabric may support scalable, parallel communication among nodes. Interconnect fabric link 206 may be a physical or logical connection within the interconnect fabric and may carry data, control signals, etc. between components. Interconnect fabric link 206 may be or include physical wires, optical paths, wireless channels, etc.

In specific embodiments, the NoC may be very wide (e.g., 256 bytes) to support high bandwidth. However, a large proportion of packets (e.g., 25% of packets) for a system workload may be 64 bytes or smaller. When these small packets are sent across the NoC interconnect fabric, the efficiency of the transfer may be low (e.g., due to high overhead per packet, low bandwidth utilization, etc.). Compressing and sending multiple packets together as a single packet eases the die crossing bandwidth bottleneck and improves the efficiency of the transfer of these packets across die to die; this improves effective product bandwidth and performance. These steps may be repeated for multiple (e.g., all) die crossings, independently. Therefore, benefits (e.g., reduced latency, reduced overhead, etc.) are compounded.

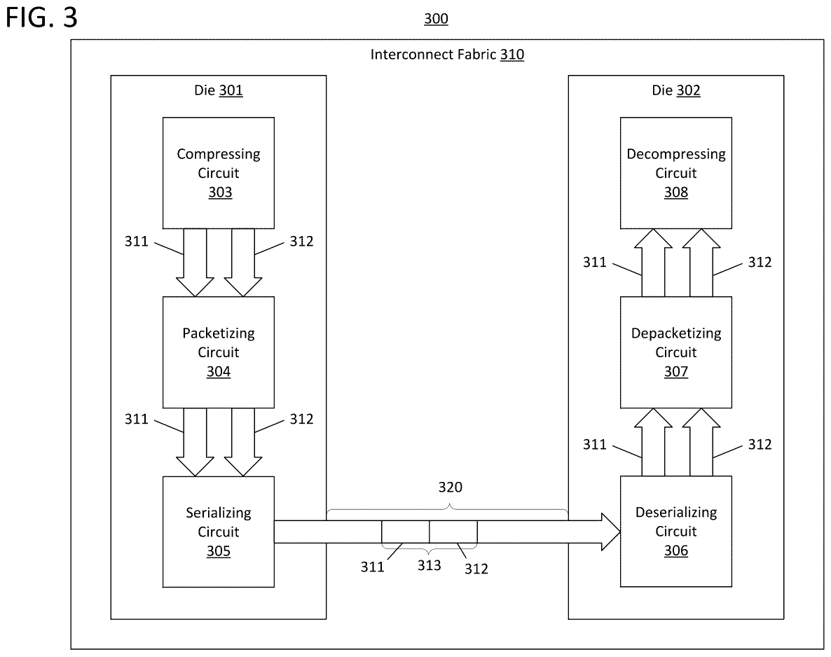

FIG. 3 illustrates an example of system 300 including die 301 and die 302 within interconnect fabric 310 in accordance with specific embodiments of the inventions disclosed herein. Interconnect fabric link 320 may be coupled to die 301 and to die 302 and may transport message 311 and message 312 from die 301 to die 302, both message 311 and message 312 sharing packet 313 of interconnect fabric link 320. Die 301 includes compressing circuit 303, packetizing circuit 304, and serializing circuit 305. Die 302 includes deserializing circuit 306, depacketizing circuit 307, and decompressing circuit 308. Illustrated boundaries are simplified for explanatory purposes; compressing circuit 303, packetizing circuit 304, and serializing circuit 305 may share circuitry or overlap. Similarly, deserializing circuit 306, depacketizing circuit 307, and decompressing circuit 308 may share circuitry or overlap. In specific embodiments, portions of system 300 may be excluded; additionally other circuits not shown may be included in system 300. A message may refer to computational data for a computation being executed by the dies in combination, instructions which are routed amongst the dies and executed by a particular node in the network, or any other data exchanged between dies.

Die 301 may determine that a size of message 311 (e.g., a first message) is smaller than or equal to a first threshold size. The threshold may be based on a bandwidth of interconnect fabric link 320 and compression algorithms of compressing circuit 303. For example, the threshold size may be more than half the bandwidth of interconnect fabric link 320 where the compression algorithms determine that the size of message 311 is equal to or less than half the bandwidth of interconnect fabric link 320 and determine that message 311 can fit in a single packet 313, with a size equal to the bandwidth, with another message that is less than or equal to half the size of packet 313.

Die 301 may decode at least a portion of a header of message 311 to determine the size of message 311. Die 301 may interpret the information encoded in the header to determine how message 311 should be processed or routed. A communication controller of die 301 may isolate the header from the rest of message 311. Isolating the header may involve simple boundary detection, as the header may be located at the start of message 311. Die 301 may parse the message header into its constituent fields such as the source and destination addresses, message type or opcode, priority level, payload size, and error-checking codes. In specific embodiments, the message header may be parsed sufficiently to determine the payload size but not to determine other aspects of the message. In specific embodiments, the communication protocol may use encoding or encryption and die 301 may decode or decrypt the header information to access its contents. Decoding or decrypting the header may involve: bit-level decoding or error detection and correction, for example. In specific embodiments, all the illustrated circuity in die 301 and die 302 of FIG. 3 can be incorporated in the routers which are connected to the inter-die connections of the system such as interconnect fabric link 320.

Compressing circuit 303 may compress message 311 based on the size of message 311 being smaller than or equal to the first threshold size. In specific embodiments, compressing circuit 303 may compress message 311 by placing it in packet 313 such that the portion of the packet taken by the message is less than half the bandwidth of the interconnect fabric link 320. In specific embodiments, compressing circuit 303 may mark message 311 and message 312 for placement in a single packet 313 with message 311 taking more than half the bandwidth of interconnect fabric link 320 and message 312 taking less than half the bandwidth of interconnect fabric link 320, such that the compressed messages 311 and 312 fit within the bandwidth.

Die 301 may determine that a size of message 312 (e.g., a second message) is smaller than or equal to a second threshold. The second threshold may be the same as or different than the first threshold. Die 301 may decode at least a portion of a header of message 312 to determine the size of message 312. Compressing circuit 303 may compress message 312 based on the size of message 312 beings smaller than or equal to a second threshold size. The second threshold size may be based on a bandwidth of interconnect fabric link 320, the compression algorithms of compressing circuit 303, and the size of message 311. For example, the second threshold size may be related to the remaining quantity of bandwidth of interconnect fabric link 320 not taken by compressed message 311, where the compression algorithms compress the size of message 312 to be equal to or less than the remaining quantity of bandwidth of interconnect fabric link 320. For example, if message 311 uses more than half the bandwidth of interconnect fabric link 320, then compressing circuit 303 may compress message 312 to a compressed size that is less than half the bandwidth of interconnect fabric link 320. In this case, the first threshold (for message 311) may be more than half of the bandwidth while the second threshold (for message 312) may be less than the first threshold. As another example, if message 311 uses half the bandwidth of interconnect fabric link 320, then compressing circuit 303 may compress message 312 to a compressed size that is equal to or less than half the bandwidth of interconnect fabric link 320. In this case, the first threshold (for message 311) may be half of the bandwidth while the second threshold (for message 312) may also be half of the bandwidth such that the second threshold is the same as the first threshold.

Compressing circuit 303 may be an encoder and may perform source encoding. By compressing message 311 (e.g. reducing the size of message 311), compressing circuit 303 may help optimize the bandwidth, reduce power consumption, and reduce latency. However, in specific embodiments of the invention compressing circuit 303 does not compress the content of message 311 and instead compresses the message by enhancing bandwidth utilization by marking message 311 and message 312 for packetization by packetizing circuit 304 in a single packet 313. In specific embodiments, compressing circuit 303 may compress the payload of message 311 and may refrain from compressing the header of message 311. The uncompressed header may allow immediate decoding by the receiver. Compressing circuit 303 may use hardware-or software-implemented algorithms. Compressing algorithms may be chosen based on the data type of message 311 and performance requirements. For example, compressing circuit 303 may use lossless compression (e.g., Huffman coding, run-length encoding (RLE), dictionary-based methods) or lossy compression. Compressing circuit 303 may use transformation and/or bit packing techniques. In specific embodiments, error-checking mechanisms may be combined with message 311, once message 311 is compressed. In specific embodiments, compressing circuit 303 may include an indication of whether message 311 was compressed within message 311. For example, two bits may indicate whether message 311 was compressed. Compressing circuit 303 may compress message 312 similarly to how it compresses message 311.

If the size of a message is larger than the threshold, then die 301 may refrain from compressing the message. Accordingly, when the message arrives at die 302, die 302 may refrain from decompressing the (not compressed) message. In specific embodiments, the message may still be packetized by packetizing circuit 304, serialized by serializing circuit 305, transported by interconnect fabric link 320, deserialized by deserializing circuit 306, and depacketized by depacketizing circuit 307, even if the message is not compressed. In specific embodiments, if a message is not compressed, then interconnect fabric link 320 may transport the message alone; that is, the message may not share (e.g., may refrain from sharing) a packet of interconnect fabric link with another message.

Packetizing circuit 304 may packetize message 311 and may packetize message 311 in a single packet 313 with message 312. The packets may be packets that are designed for being transmitted efficiently over interconnect fabric link 320. As such, the packets may have a size that is equal to a bandwidth of interconnect fabric link 320. Each packet may include a header (e.g., metadata) to ensure message 311 is correctly reassembled at die 302. Packet headers may indicate compression details, such as the compression algorithm used by compressing circuit 303. Packets may be fixed-length or variable-length. Critical packets may be assigned higher priority. Packetizing circuit 304 may packetize message 312 similarly to how it packetizes message 311.

Serializing circuit 305 may convert message 311 into a linear sequence of bits for transmission over interconnect fabric link 320. Serialization may ensure that data may be correctly interpreted by die 302. Serializing circuit 305 may divide message 311 into logical units (e.g., header, payload, trailer) and encode data to match requirements of a transmission protocol. Serializing circuit 305 may convert message 311 from parallel formatting into a single serial data stream and may structure message 311 with framing bits to delineate the start and end of the serialized data. Serializing circuit 305 may prepare the serialized bitstream of message 311 for transmission over interconnect fabric link 320 by using processes such as voltage leveling, differential signaling, and encoding. Serializing circuit 305 may serialize message 312 similarly to how it serializes message 311.

Interconnect fabric link 320 may be a physical medium coupled to die 301 and to die 302. Interconnect fabric link 320 may transport message 311 and message 312 from die 301 to die 302. Message 311 and message 312 may be transmitted in parallel and take up the entire bandwidth of interconnect fabric link 320. Message 311 and message 312 may be transmitted simultaneously or sequentially through the same physical medium or logical link, utilizing portions of the available capacity of interconnect fabric link 320. For example, message 311 and message 312 may share a time slot (e.g., in time division multiplexing (TDM)), share a frequency band (e.g., in frequency division multiplexing (FDM)), or share the same physical path between die 301 and die 302 (e.g., in space division multiplexing (SDM)).

Messages 311 and 312 may be transmitted more efficiently using the approach described with reference to FIG. 3 than if they did not. For example, sending message 311 and message 312 separately over interconnect fabric link 320 may result in bandwidth underutilization. Messages 311 and 312 may be small enough that they both fit into a single packet 313 for transmission across interconnect fabric link 320. In specific embodiments, each message 311 and 312 may be equal to or less than half the size of the bandwidth. In specific embodiments, message 311, may be larger than half the size of the bandwidth and message 312 may be equal to or less than the remainder of the bandwidth. In specific embodiments, messages 311 and 312 may be small enough that an additional (e.g., third) message may also fit (e.g., when compressed) in the bandwidth such that message 311, message 312, and the third message are transported together via a packet in interconnect fabric link 320. The third message may also be compressed via compressing circuit 303, packetized by packetizing circuit 304, serialized by serializing circuit 305, deserialized by deserializing circuit 306, depacketized by depacketizing circuit 307, and decompressed by decompressing circuit 308 along with messages 311 and 312. The same principles apply to any number of messages that can be sent on a single packet through interconnect fabric link 320.

Deserializing circuit 306 may convert the serialized data stream of message 311 back into its original form (e.g., parallel form, structured form). Deserializing circuit 306 on die 302 may receive message 311 from die 301 via interconnect fabric link 320. In specific embodiments, die 302 may buffer the incoming data to handle variations in transmission timing or rate. Deserializing circuit 306 may parse the serialized stream of message 311 to extract data frames using protocol-defined markers. In specific embodiments, deserializing circuit 306 may check for errors.

Depacketizing circuit 307 may receive, validate, and reorder the packet or packets used to transmit message 311 and message 312. Depacketizing circuit 307 may use error-checking codes and may acknowledge successful reception. Packets may be reassembled based on sequence numbers to reconstruct messages 311 and 312. Each packet may include a header (e.g., metadata) to ensure messages 311 and 312 are correctly reassembled at die 302. Packet headers may indicate compression details, such as the compression algorithm used by compressing circuit 303.

Decompressing circuit 308 may be a decoder and may perform source decoding. Decompressing circuit 308, in die 302, may decompress message 311 and message 312 based on compressing circuit 303 compressing message 311 and message 312. If a message was not compressed by compressing circuit 303, then decompressing circuit 308 may refrain from decompressing the (uncompressed) message. In specific embodiments, the message may indicate whether it was compressed or not (e.g., via two bits). Decompressing circuit 308 can therefore be responsible for separating message 311 and message 312 into separate packets for further transmission through the network and can in the alternative or in combination be responsible for decompressing the actual content of message 311 and message 312. Message 311 and message 312 may be decompressed through various decompression techniques such as zero extension to create a required message size. For example, message 311 may correspond to a flit and decompressing circuit 308 may zero extend message 311 to construct a legal flit (e.g., based on the NoC of die 302) where the lower 128 bytes carry the useful information.

In specific embodiments, a message may undergo compression, packetization, and serialization (e.g., if a message is smaller than or equal to a threshold size, such as 64 bytes). In specific embodiments, a message may undergo packetization and serialization without compression (e.g., if the message is larger than a threshold size). Compressing a small message (smaller than or equal to a threshold size) may increase bandwidth efficiency while adding minimal latency or without adding any latency (e.g., compared to the packetization and serialization steps and die crossing generally). For example, hardware to decode message headers (e.g., NoC header) may already be implemented in a system without a compressing circuit for inter-die communication. Compressing messages, therefore, may add very little hardware, if any, and may add very little latency, if any.

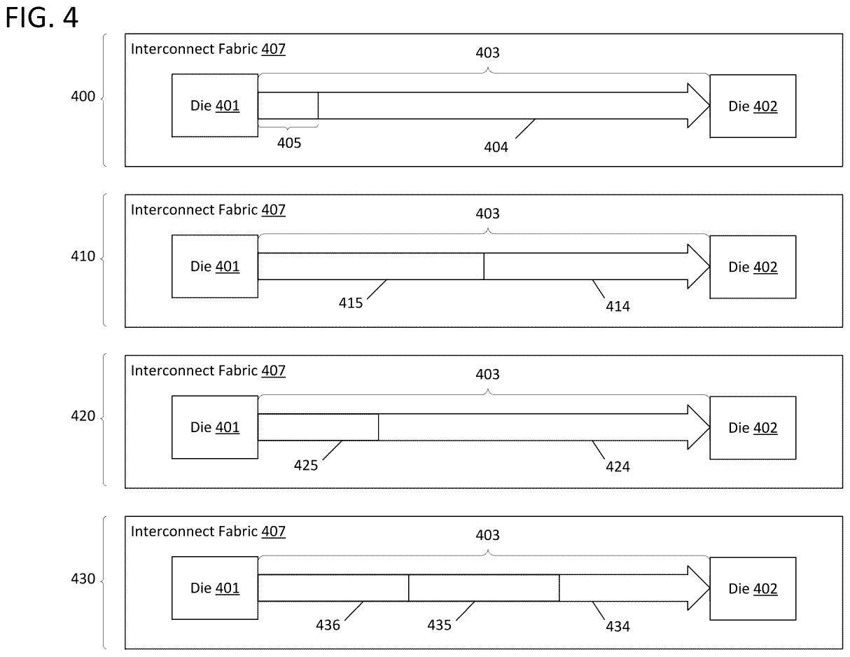

FIG. 4 illustrates examples of interconnect fabric 407 connecting die 401 and die 402 with messages of differing sizes using bandwidth 403 in accordance with specific embodiments of the inventions disclosed herein. Different sizes of messages may satisfy different thresholds, allowing different combinations and quantities of compressed and uncompressed messages to share a packet, with the maximum size of the packet being the size of the bandwidth 403. Interconnect fabric 407 may link die 401 and die 402 such that messages may travel between them (e.g., die 401 may share an interconnect fabric with die 402). Die 401 may be physically separate from die 402. In FIG. 4, messages are sent from die 401 to die 402, however die 402 may also be capable of sending messages to die 401.

In example 400, message 404 may not satisfy a threshold size. That is, message 404 may be larger than a threshold size. The threshold may be based on a message size that would allow an additional message to fit within a packet in bandwidth 403 in addition to message 404 (e.g., considering a compression size of message 404). Die 401 may decode at least a portion of the header of message 404 to determine the size of message 404. In specific embodiments, die 401 may refrain from compressing message 404 (e.g., due to message 404 being larger than the threshold size) such that message 404 may not be compressed. As shown in FIG. 4, a packet containing message 404 may not use the entire bandwidth 403, such that portion 405 remains unused. In specific embodiments, a packet containing message 404 may use the entire bandwidth 403.

In example 410, message 414 may satisfy a threshold size. That is, message 414 may be smaller than or equal to a threshold size. The threshold may be hardware or software implemented and may impose a limit on the size of the message in various ways. For example, in specific embodiments, determining whether a size of a message is smaller than or equal to a threshold may include die 401 comparing the size of message 414 to a threshold size. In specific embodiments, determining whether a size of a message is smaller than or equal to a threshold may include die 401 estimating a compressed size of message 414 and comparing the estimated compressed size to a threshold size. In specific embodiments, determining whether a size of a message is smaller than or equal to a threshold may include die 401 compressing message 414 to find the actual compressed size of message 414 and comparing the actual compressed size to a threshold size. Die 401 may decode at least a portion of the header of message 414 to determine the size of message 414. The threshold size for an uncompressed message may be more than half of bandwidth 403 such that the size of message 414 is equal to (or less than) half of bandwidth 403. The size of message 415 may also be compared to a threshold size.

The threshold size may be based on the bandwidth size of the interconnect fabric link. The threshold size may refer to more than half of bandwidth 403 and be compared to an uncompressed size of message 414 such that compressed message 414 may be equal to (or less than) half of bandwidth 403. Alternatively, the threshold size can be compared to a size of message 414 such that uncompressed message 414 may be equal to (or less than) half of bandwidth 403. Compressed message 415, then, may also be equal to (or less than) half of bandwidth 403. Die 401 may determine that the size of message 414 is smaller than or equal to a threshold size such that message 414 and message 415 may fit within a packet the size of bandwidth 403. Die 401 may decode at least a portion of the header of message 414 and at least a portion of the header of message 415 to determine the size of message 414 and the size of message 415. In specific embodiments, a packet containing message 414 and message 415 together may use the entire bandwidth 403. In specific embodiments, a packet containing message 414 and message 415 together may not use the entire bandwidth 403, such that a portion may remain unused.

In example 420, message 424 may satisfy a threshold size. That is, message 424 may be smaller than or equal to a threshold size. The threshold size may be based on the bandwidth size of the interconnect fabric link and may be based on the size of other messages. The threshold size may be such that compressed message 424 may be larger than half of bandwidth 403 (e.g., take up more than half of the shared packet). Compressed message 425, then, may be less than half of bandwidth 403 (e.g., take up less than half of the shared packet). The threshold size may be based on a minimum expected compressed message size, a minimum expected compressed message size of a batch of messages, an expected compressed size of message 425, a size of message 425, or another message size. If no additional message were expected to fit in the bandwidth space left by message 424, then message 424 may be uncompressed and sent to die 402 alone, similar to example 400, or may be compressed and sent to die 402 alone. The threshold size compared to message 424 may indicate whether another message may fit within bandwidth 403 along with compressed message 424, where message 424 and the other message may not be the same size. Die 401 may decode at least a portion of the header of message 424 to determine the size of message 424 and may decode at least a portion of the header of message 425 to determine the size of message 425.

The threshold size may refer to whether the remaining bandwidth left from compressed message 424 is larger than a minimum compressed message size. If the remaining bandwidth is equal to or greater than a minimum compressed message size, then die 401 may search among messages to be sent to die 402 for a message that, when compressed, may be equal to the minimum compressed message size (this message may then be message 425). If the remaining bandwidth were less than a minimum compressed message size, then die 401 refrain from compressing message 424 and refrain from adding another message to the packet containing message 424. As another example, the threshold size may refer to whether the remaining bandwidth left from compressed message 424 is larger than an average compressed message size or a most common compressed message size.

The threshold size may refer to whether the remaining bandwidth left from compressed message 424 is larger than a minimum compressed message size in a group of messages that die 401 has to send to die 402. If the remaining bandwidth is equal to or greater than a minimum compressed message size in that group of messages, then die 401 may search for a message within the group of messages for a message that, when compressed, may be equal to or larger than the minimum compressed message size and equal to or less than the remaining bandwidth. A message within this window may be selected as message 425. If the remaining bandwidth were less than a minimum compressed message size in the group of messages, then die 401 refrain from compressing message 424 and refrain from adding another message to the packet containing message 424. If the smallest message in the group of messages is selected as message 425, then die 401 may recalibrate the threshold based on the remaining messages in the group of messages (e.g., pick the next smallest message as a baseline for the threshold, research for a smallest message in the group of messages, etc.). As another example, the threshold size may refer to whether the remaining bandwidth left from compressed message 424 is larger than an average compressed message size or a most common compressed message size in a group of message that die 401 has to send to die 402.

Die 401 may determine that the size of message 424 is smaller than or equal to a threshold size such that compressed message 424 and compressed message 425 fit within a single packet the size of bandwidth 403. Message 425 may also be compared to a second threshold size, which may be different than the threshold size compared to message 424. The second threshold size may be based on the remaining portion of bandwidth 403 not used by compressed message 424. Die 401 may determine that the size of message 425 is smaller than or equal to the second threshold size such that compressed message 424 and compressed message 425 fit within a single packet the size of bandwidth 403. In specific embodiments, a packet containing message 424 and message 425 together may use the entire bandwidth 403. In specific embodiments, a packet containing message 424 and message 425 together may not use the entire bandwidth 403, such that a portion of bandwidth 403 may remain unused.

In example 430, message 434 may satisfy a threshold size. That is, message 434 may be smaller than or equal to a threshold size. The threshold size may be based on the bandwidth size of the interconnect fabric link and may be based on the size of other messages. The threshold size may be such that the size of compressed message 434 may be equal to (or less than) a third of bandwidth 403. Compressed message 435 may also be equal to (or less than) a third of bandwidth 403; and compressed message 436 may also be equal to (or less than) a third of bandwidth 403. Die 401 may determine that the size of message 434 is smaller than or equal to a threshold size such that compressed message 434, compressed message 435, and compressed message 436 fit within bandwidth 403. Message 435 and message 436 may also be compared to a second threshold size and a third threshold size, respectively. In the case of example 430, the threshold size, the second threshold size, and the third threshold size may each be such that compressed message 434, compressed message 435, and compressed message 436 use a third of bandwidth 403 when packeted together in a single packet. In specific embodiments, the second threshold size may be based on the remaining portion of bandwidth 403 not used by compressed message 434; and the third threshold size may be based on the remaining portion of bandwidth 403 not used by compressed message 434 or by compressed message 435. In specific embodiments, a packet containing message 434, message 435, and message 436 together may use the entire bandwidth 403. In specific embodiments, a packet containing message 434, message 435, and message 436 together may not use the entire bandwidth 403, such that a portion of bandwidth 403 may remain unused. Die 401 may decode at least a portion of the header of message 434, at least a portion of the header of message 435, and at least a portion of the header of message 436 to determine the sizes of messages 434, 435, and 436 respectively.

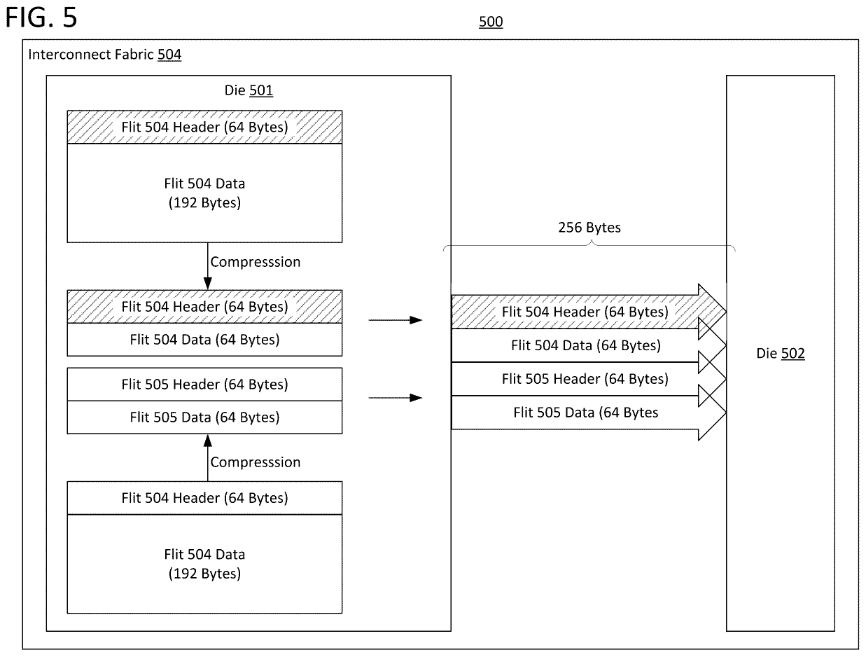

FIG. 5 illustrates an example of system 500 with a bandwidth of an interconnect fabric link between die 501 and die 502 split evenly between flit 504 and flit 505 in accordance with specific embodiments of the inventions disclosed herein. FIG. 5 may illustrate a specific case of example of 410.

In specific embodiments, a workload may have a significant quantity of messages with sizes less than or equal to the threshold size. For example, more than 25% of inter-die messages (e.g., flits) of a system may, if compressed, be equal to or less than 128 Bytes (e.g., 64 Bytes of payload or data and 64 Bytes of header). For system 500, with an inter-die bandwidth of 256 Bytes (e.g., a 256 Byte NoC), a 128 Byte message only uses 50% of the bandwidth (e.g., 50% NoC/PHY utilization). By compressing two flits such that they are both 128 Bytes (or less), the flits may share a single packet the size of the bandwidth, resulting in 100% bandwidth utilization. Transporting two messages together doubles the effective PHY bandwidth, resulting in significant quantifiable performance benefits (e.g., for AI workloads).

In specific embodiments, the header portions of flits are not compressed, staying at 64 Bytes even if the data portion of the flits are compressed. For example, a flit may be 256 Bytes including the header. In this case, a minimum packet size may be, for example, 128 Bytes (including 64 Bytes compressed flit data and 64 Bytes uncompressed flit header). Even without compressing the header, a 256 Bytes flit may be compressed to 50% its original size. In specific embodiments, for flits that are smaller than 64 Bytes when compressed, more than two flits may be packed together to further improve bandwidth utilization. In specific embodiments, two flits may be packeted together in a packet without either flit being made smaller. That is, two flits together may be smaller than the maximum packet size without processing the flits to be smaller than their original sizes.

Die 501 and die 502 may be any of a variety of types of die. For example, die 501 and/or die 502 may be a CPU die, a CPU chiplet, AI accelerator die, memory die (e.g., DDR die), scale out die (e.g., Ethernet die), etc. Communication between die 501 and die 502 may include maintaining a single NoC protocol or may cross into different NoC protocols. In specific embodiments, a CPU die and an AI accelerator die may communicate. The CPU die may transfer 32 Bytes of data, or a smaller quantity of data. If these data transfers were to take the entire bandwidth through the physical layer (e.g., not sharing a packet with another data transfer, and therefore not efficiently using the bandwidth), then the data transfers may cut into direct memory access and overlay bandwidth. Overlay and CPU traffic may share the die-to-die physical layer. Therefore, two data transfers being packeted together in a packet the size of the bandwidth may improve bandwidth efficiency for a variety of situations.

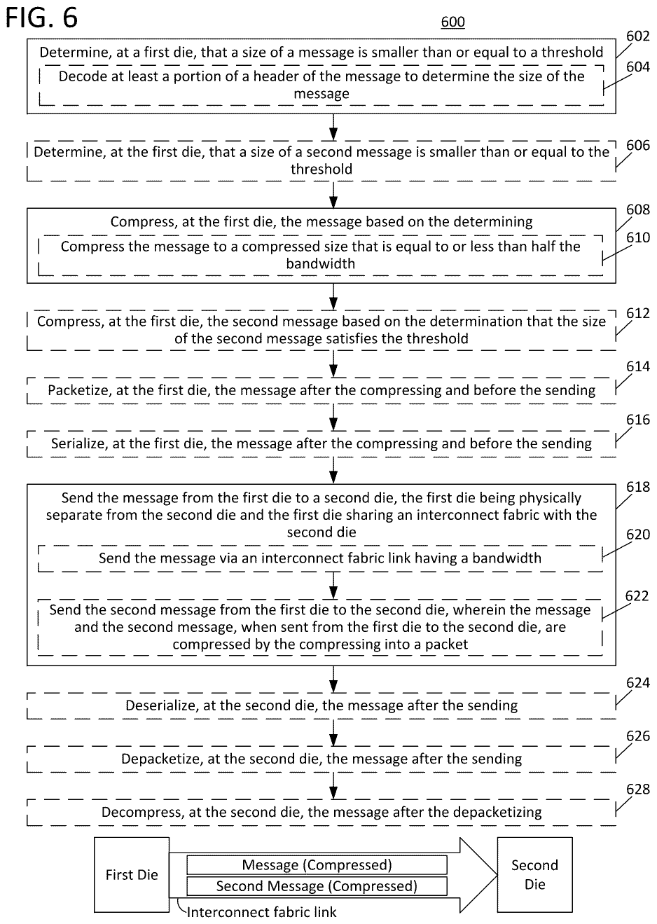

FIG. 6 illustrates an example of method 600 for compressing a message if the message size is smaller than or equal to a threshold size in accordance with specific embodiments of the inventions disclosed herein. Method 600 may be performed by a system including a first die, a second die, and an interconnect fabric link coupled to the first die and the second die capable of transporting a first message and a second message. The first die may include a compressing circuit; the second die may include a decompressing circuit. In specific embodiments, the system may include a third message. Steps or portions of steps of method 600 may be duplicated, rearranged, omitted, or otherwise deviate from the form shown. In specific embodiments, additional steps may be added to method 600. In specific embodiments, portions of method 600 may be performed in series or in parallel, or may overlap.

At step 602, a size of a message may be determined to be smaller than or equal to a threshold. The message may be from a first die to a second die in a network. The network may be a NoC. The threshold may be based on the bandwidth of an interconnect fabric link that connects the first die and the second die. The threshold may be based on the sizes of other (e.g., second, third) messages for transport from the first die to the second die. The first die may be physically separate from the second die and may share an interconnect fabric with the second die.

In specific embodiments and as part of determining that the size of the message is smaller than or equal to the threshold, at step 604, at least a portion of a header of the message may be decoded. The portion (or more) of the header may be decoded to determine the size of the message.

In specific embodiments, at step 606, the size of a second message may be determined to be smaller than or equal to the threshold. The determination may be made at the first die.

At step 608, the message may be compressed based on determining that the size of the message is smaller than or equal to the threshold (e.g., at step 602). Compressing the message may refer to putting a given number of messages in fewer packets. In specific embodiments, compressing the message may also refer to encoding the bits of the message in a way that takes up less space.

In specific embodiments and as part of compressing the message, at step 610, the message may be compressed to a compressed size that is equal to or less than half of the bandwidth of the interconnect fabric link. The first die may compress the message into a packet. The packet size may be equal to the bandwidth size of the interconnect fabric link.

In specific embodiments, at step 612, the second message may be compressed at the first die. The second message may be compressed based on the determination that the size of the second message satisfies the threshold (e.g., at step 606). The first die may compress the message and the second message together into a single packet. The size of the packet may be set by a physical layer protocol of the interconnect fabric link. The packet size may be equal to the bandwidth size of the interconnect fabric link. In specific embodiments, the second message may be compressed to a compressed size that is equal to or less than half of the bandwidth of the interconnect fabric link.

In specific embodiments, at step 614, the message may be packetized at the first die. The message may be packetized after the message is compressed (e.g., at step 608) and before the message is sent to the second die (e.g., at step 618). In specific embodiments, the second message may be packetized at the first die.

In specific embodiments, at step 616, the message may be serialized. The message may be serialized after the message is compressed (e.g., at step 608) and before the message is sent to the second die (e.g., at step 618). In specific embodiments, the message may be serialized after the message is packetized (e.g., at step 614). In specific embodiments, the second message may be serialized at the first die.

At step 618, the message may be sent from the first die to the second die. The message may be sent in a packet. The size of the packet may be set by a physical layer protocol of the interconnect fabric link. The first die may be physically separate from the second die and may share an interconnect fabric with the second die. In specific embodiments, the first die and the second die are part of a NoC and share the same NoC protocol.

In specific embodiments, and as part of sending the message from the first die to the second die, at step 620, the message may be sent via an interconnect fabric link having a bandwidth. In specific embodiments, the threshold is more than half of the bandwidth.

In specific embodiments, and as part of sending the message, at step 622, the second message may be sent from the first die to the second die. The message and the second message, when sent from the first die to the second die, may be compressed by the compressing into a packet. The message and the second message may be compressed into the same packet. The packet may have a size equal to the bandwidth of the interconnect fabric link of the interconnect fabric.

In specific embodiments, at step 624, the message may be deserialized at the second die. The message may be deserialized after the message is sent from the first die to the second die (e.g., at step 618). In specific embodiments, the second message may be deserialized at the second die.

In specific embodiments, at step 626, the message may be depacketized at the second die. The message may be depacketized after the message is sent from the first die to the second die (e.g., at step 618). In specific embodiments, the message may be depacketized after the message is deserialized (e.g., at step 626). In specific embodiments, the second message may be depacketized at the second die.

In specific embodiments, at step 628, the message may be decompressed at the second die. In specific embodiments, the message may be decompressed after the message is deserialized (e.g., at step 622). In specific embodiments, the message may be decompressed after the message is depacketized (e.g., at step 626). In specific embodiments, the second message may be decompressed at the second die.

By sharing a packet when being transported across the interconnect fabric link, the message and second message may be transmitted more efficiently than if they were transported in separated packets. For example, sending the message and the second message using the same packet may reduce overhead. The message and the second message may be small enough that they both fit, when compressed, within the same packet, the packet having the same size as the bandwidth. The steps of method 600 may be repeated for various messages at multiple die crossings, independently. Therefore, the benefits of reduced overhead and reduced latency are compounded.

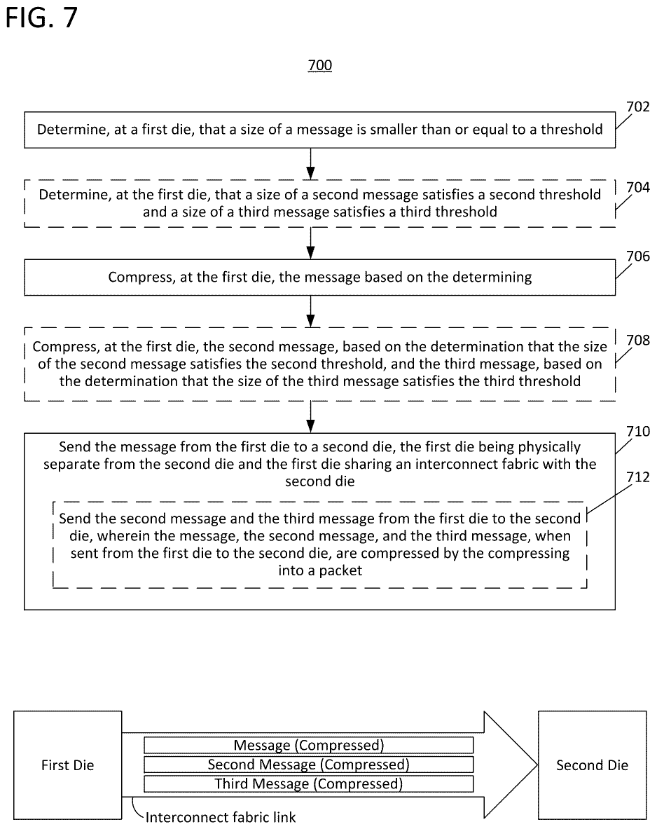

FIG. 7 illustrates an example of method 700 for compressing three messages if the message sizes are smaller than or equal to respective threshold sizes in accordance with specific embodiments of the inventions disclosed herein. Method 700 may be performed by a system including a first die, a second die, and an interconnect fabric link coupled to the first die and the second die capable of transporting messages. The first die may include a compressing circuit; the second die may include a decompressing circuit. In specific embodiments, the system may include first, second, and third messages. Steps or portions of steps of method 700 may be duplicated, rearranged, omitted, or otherwise deviate from the form shown. In specific embodiments, additional steps may be added to method 700. In specific embodiments, portions of method 700 may be performed in series or in parallel, or may overlap. Aspects of method 600 may be implemented in method 700.

At step 702, a size of a message may be determined to be smaller than or equal to a threshold. The message may be from a first die to a second die in a network. The network may be a NoC. The threshold may be based on the bandwidth of an interconnect fabric link that connects the first die and the second die. The threshold may be based on the size of other (e.g., second, third) messages for transport from the first die to the second die. The first die may be physically separate from the second die and may share an interconnect fabric with the second die.

In specific embodiments, at step 704, the size of a second message may be determined to be smaller than or equal to a second threshold and the size of a third message may be determined to be smaller than or equal to a third threshold. The determinations may be made at the first die. In specific embodiments, the second threshold may be based on the sizes of other (e.g., first, third) messages and the bandwidth of the interconnect fabric link. In specific embodiments, the third threshold may be based on the sizes of other (e.g., first, second) messages and the bandwidth of the interconnect fabric link. In specific embodiments, the second threshold may be based on expected compressed sizes of other (e.g., first, third) messages and the bandwidth of the interconnect fabric link. In specific embodiments, the third threshold may be based on expected compressed sizes of other (e.g., first, second) messages and the bandwidth of the interconnect fabric link.

At step 706, the message may be compressed based on determining that the size of the message is smaller than or equal to the threshold (e.g., at step 702). In specific embodiments, the message may be compressed to a compressed size that is equal to or less than a third of the bandwidth of the interconnect fabric link. Compressing a message may refer to putting a given number of messages in fewer packets with the message. In specific embodiments, compressing the message may also refer to encoding the bits of the message in a way that takes up less space. The first die may compress the message into a packet. The packet size may be equal to the bandwidth size of the interconnect fabric link.

In specific embodiments, at step 708, the second message and the third message may be compressed at the first die. The second message may be compressed based on the determination that the size of the second message satisfies the second threshold (e.g., at step 704). The third message may be compressed based on the determination that the size of the third message satisfies the third threshold (e.g., at step 704). In specific embodiments, the second message and the third message may each be compressed to a compressed size that is equal to or less than a third of the bandwidth of the interconnect fabric link. The first die may compress the message, the second message, and the third message together into a single packet. The size of the packet may be set by a physical layer protocol of the interconnect fabric link. The packet size may be equal to the bandwidth size of the interconnect fabric link.

At step 710, the message may be sent from the first die to the second die. The message may be sent in a packet. The size of the packet may be set by a physical layer protocol of the interconnect fabric link. The first die may be physically separate from the second die and may share an interconnect fabric with the second die. In specific embodiments, the first die and the second die are part of a NoC and share the same NoC protocol.

In specific embodiments, and as part of sending the message, at step 712, the second message and the third message may be sent from the first die to the second die. The message, the second message, and the third message, when sent from the first die to the second die, may be compressed by the compressing into a packet. The message, the second message, and the third message may be compressed into the same packet. The packet may have a size equal to the bandwidth of the interconnect fabric link of the interconnect fabric.

By sharing a packet when being transported across the interconnect fabric link, the message, the second message, and the third message may be transmitted more efficiently than if they were transported in separate packets. For example, sending the messages using the same packet may reduce overhead and latency. The message, the second message, and the third message may be small enough that, when compressed, they all fit together within the same packet, the packet having the same size as the bandwidth of the interconnect fabric link connecting the dies. The steps of method 700 may be repeated for various messages at multiple die crossings, independently. Therefore, the benefits of reduced overhead and reduced latency are compounded.

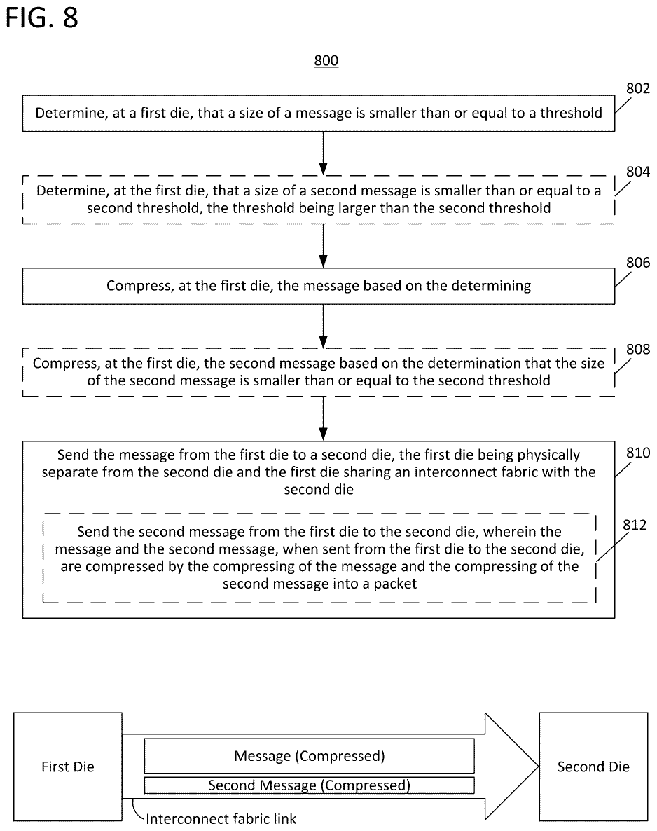

FIG. 8 illustrates an example of method 800 for compressing two messages if the message sizes are smaller than or equal to respective threshold sizes, the two messages being different sizes in accordance with specific embodiments of the inventions disclosed herein. Method 800 may be performed by a system including a first die, a second die, and an interconnect fabric link coupled to the first die and the second die capable of transporting messages. The first die may include a compressing circuit; the second die may include a decompressing circuit. In specific embodiments, the system may include a first and a second message. Steps or portions of steps of method 800 may be duplicated, rearranged, omitted, or otherwise deviate from the form shown. In specific embodiments, additional steps may be added to method 800. In specific embodiments, portions of method 800 may be performed in series or in parallel, or may overlap. Aspects of method 600, method 700, or both may be implemented in method 800.

At step 802, a size of a message may be determined to be smaller than or equal to a threshold. The message may be from a first die to a second die in a network. The network may be a NoC. The threshold may be based on the bandwidth of an interconnect fabric link that connects the first die and the second die. The threshold may be based on the size of other (e.g., second) messages for transport from the first die to the second die. The first die may be physically separate from the second die and may share an interconnect fabric with the second die.

In specific embodiments, at step 804, the size of a second message may be determined to be smaller than or equal to a second threshold. The determinations may be made at the first die. The threshold used for the message (e.g., at step 802) may be larger than the second threshold used for the second message. In specific embodiments, the second threshold may be based on the size of the other (e.g., first) message and the bandwidth of the interconnect fabric link. In specific embodiments, the second threshold may be based on an expected compressed size of the other (e.g., first) message and the bandwidth of the interconnect fabric link.

At step 806, the message may be compressed based on determining that the size of the message is smaller than or equal to the threshold (e.g., at step 802). In specific embodiments, compressing the message may also refer to encoding the bits of the message in a way that takes up less space. The first die may compress the message into a packet. The packet size may be equal to the bandwidth size of the interconnect fabric link. In specific embodiments, the message may be compressed to a compressed size that is more than half the bandwidth of the interconnect fabric link.

In specific embodiments, at step 808, the second message may be compressed at the first die. The second message may be compressed based on the determination that the size of the second message satisfies the second threshold (e.g., at step 804). The first die may compress the message and the second message together into a single packet. The size of the packet may be set by a physical layer protocol of the interconnect fabric link. The packet size may be equal to the bandwidth size of the interconnect fabric link. In specific embodiments, the second message may be compressed to a compressed size that is less than half of the bandwidth of the interconnect fabric link.

At step 810, the message may be sent from the first die to the second die. The message may be sent in a packet. The size of the packet may be set by a physical layer protocol of the interconnect fabric link. The first die may be physically separate from the second die and may share an interconnect fabric with the second die. In specific embodiments, the first die and the second die may be part of a NoC and share the same NoC protocol.

In specific embodiments, and as part of sending the message, at step 812, the second message may be sent from the first die to the second die. The message and the second message, when sent from the first die to the second die, may be compressed by the compressing of the message and the compressing of the second message into a packet. The message and the second message may be compressed into the same packet. The packet may have a size equal to the bandwidth of the interconnect fabric link of the interconnect fabric. The message may use more bandwidth than the second message.

By sharing a packet when being transported across the interconnect fabric link, the message and the second message may be transmitted more efficiently than if they were transported in separate packets. For example, sending the messages using the same packet may reduce overhead and latency. The message and the second message may be small enough that, when compressed, they both fit together within the same packet, the packet having the same size as the bandwidth of the interconnect fabric link connecting the dies. The steps of method 800 may be repeated for various messages at multiple die crossings, independently. Therefore, the benefits of reduced overhead and reduced latency are compounded.

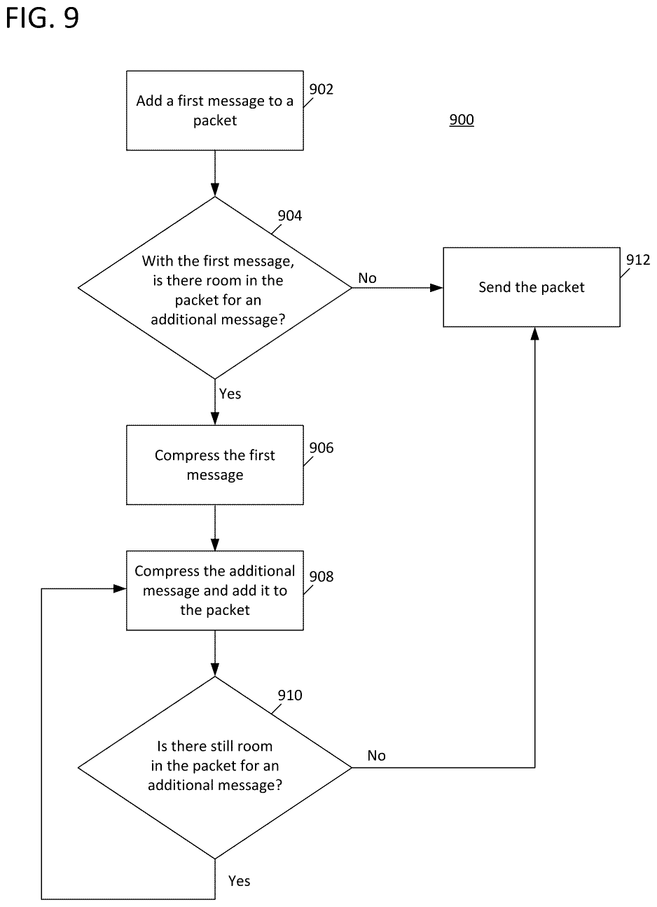

FIG. 9 illustrates an example of flowchart 900 for compressing a message if the message size is smaller than or equal to a threshold size in accordance with specific embodiments of the inventions disclosed herein. Flowchart 900 may be performed by a system including a first die and compression circuitry. In specific embodiments, the system may include an interconnect fabric link coupled to the first die and to a second die, where the interconnect fabric link may be capable of transporting one or more messages from the first die to the second die. The second die may include a decompressing circuit. Steps or portions of steps of flowchart 900 may be duplicated, rearranged, omitted, or otherwise deviate from the form shown. In specific embodiments, additional steps may be added to flowchart 900. In specific embodiments, portions of flowchart 900 may be performed in series or in parallel, or may overlap.

At step 902, a first die may add a first message to a packet. The packet may include one or more messages that the first die transfers together to a second die. That is, one or more messages may be compressed to the same packet to be transported between the first die and the second die. In specific embodiments, the first message may be added to a queue to be added to the packet at a later time.

At step 904, the first die may consider the available space in the packet of the interconnect fabric link left after the first message is assigned to the packet. For example, the first die may determine whether the first message would leave room in the packet for an additional message, where the packet has a maximum size equal to the bandwidth of the interconnect fabric link. The “additional message” may be a specific message having a specific size or may generally refer to a message in a group of available messages to be sent to the second die (the messages in the group having the same size or being within a size range). In specific embodiments, the first message and the additional message may be shortened to fit together in the same packet, in other embodiments, the first message and the additional message may not be preprocessed or altered but rather fit within the same packet in their original forms. To determine whether the additional message would fit within the packet, the first die may consider the original size of the message and/or the additional message, the first die may estimate a compressed (e.g., shortened) size of the first message and/or the additional message, may compress the first message and/or the additional message to find the actual compressed sizes, or may set a threshold uncompressed maximum size of the first message and/or the additional message, among other methods. If there would be space for an additional message in the packet, then flowchart 900 continues to step 906. If there would not be space for an additional message in the packet, then flowchart 900 continues to step 912.

At step 906, the first message may be compressed into a packet. The first message may be compressed to a compressed size that is more than half the bandwidth, equal to or less than half of the bandwidth, or equal to or less than a third of the bandwidth, etc. A compressing circuit may use a variety of compressing algorithms to compress the first message. Bits associated with the message may indicate whether the message is compressed or not. In specific embodiments, step 906 may be performed before step 904 or as part of step 904.

At step 908, the additional message may be compressed and added to the packet. In specific embodiments, the additional message may be added to a queue to be added to the packet at a later time. The “additional message” may be the specific message compared to the available bandwidth or may be the message in the group of available messages (e.g., from step 904 if this is the first occurrence of step 908, or from step 910 if this is a second or subsequent occurrence of step 908). By the end of the first occurrence of step 908, the packet includes the compressed first message and the compressed first additional message.

At step 910, the first die may consider the available space in the packet left over from the first message and the first additional message. For example, the first die may determine whether the first message and the first additional message would leave room in the bandwidth for an additional message. The second “additional message” may be a specific message having a specific size or may generally refer to a message in a group of available messages to be sent to the second die. To determine whether the second additional message would fit within the packet, the first die may consider the original size of the message, the first additional message and/or the second additional message; the first die may estimate a compressed size of the first message, the first additional message, and/or the second additional message; may compress the first message, the first additional message and/or the second additional message to find the actual compressed sizes; or may set a threshold uncompressed maximum size of the first message, the first additional message, and/or the second additional message, among other methods. If there would be space for an additional message in the packet, then flowchart 900 loops back to step 908. If there would not be space for an additional message in the packet, then flowchart 900 continues to step 912.

If flowchart 900 repeats step 908, the additional message may be compressed and added to the packet. By the end of the second occurrence of step 908, the packet includes the compressed first message, the compressed first additional message, and the compressed second additional message. In specific embodiments, by the end of the second occurrence of step 908, a queue for inputting messages into the packet may include the compressed first message, the compressed first additional message, and the compressed second additional message. As flowchart 900 loops through steps 908 and 910, more additional messages may be compressed and added to the packet. For example, by the end of the third occurrence of step 908, the packet may include the compressed first message, the compressed first additional message, the compressed second additional message, and the compressed third additional message.

At step 912, the packet may be sent from the first die to the second die on the interconnect fabric link. If the process of flowchart 900 went directly to step 912 from step 904, then the packet may include only the first message, which may be compressed or uncompressed. If the process of flowchart 900 performed steps 908 and 910 once each, then the packet may include the compressed first message and the compressed first additional message. If the process of flowchart 900 performed steps 908 and 910 twice each, then the packet may include the compressed first message, the compressed first additional message, and the compressed second additional message.

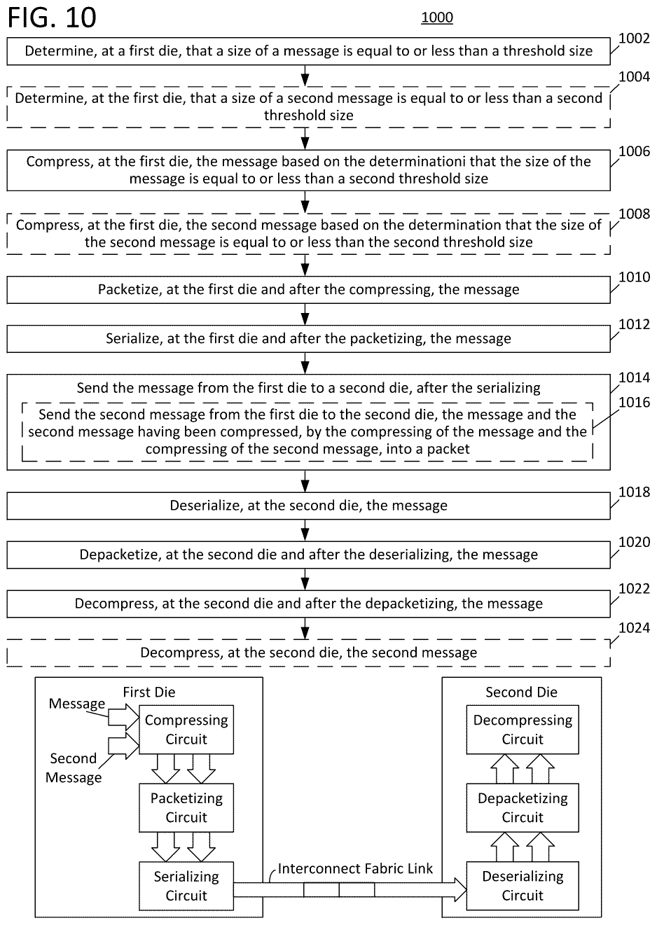

FIG. 10 illustrates an example of method 1000 for compressing, packetizing, and serializing a message if the message size is smaller than or equal to a threshold size in accordance with specific embodiments of the inventions disclosed herein. Method 1000 may be performed by a system including a first die, a second die, and an interconnect fabric link coupled to the first die and the second die capable of transporting a first message and a second message. The first die may include a compressing circuit, a packetizing circuit, and a serializing circuit; the second die may include a decompressing circuit, a depacketizing circuit, and a deserializing circuit. The system may include any quantity of messages. Steps or portions of steps of method 1000 may be duplicated, rearranged, omitted, or otherwise deviate from the form shown. In specific embodiments, additional steps may be added to method 1000. In specific embodiments, portions of method 1000 may be performed in series or in parallel, or may overlap. Aspects of method 600, method 700, method 800, or a combination thereof may be implemented in method 1000.

At step 1002, a size of a message may be determined to be equal to or less than a threshold size. The determination may be made at a first die.

In specific embodiments, at step 1004, the second message may be determined to be equal to or less than a second threshold size. The determination may be made at the first die.

At step 1006, the message may be compressed at the first die. The message may be compressed based on determining that the size of the message is equal to or less than the threshold size (e.g., at step 1002). Compressing a message may refer to putting a message in fewer packets. In specific embodiments, compressing the message may also refer to encoding the bits of the message in a way that takes up less space.

In specific embodiments, at step 1008, the second message may be compressed at the first die. The second message may be compressed based on determining that the size of the second message is equal to or less than the second threshold size (e.g., at step 1004).

At step 1010, the message may be packetized at the first die after the compressing (e.g., at step 1006). In specific embodiments, the second message may be packetized at the first die.

At step 1012, the message may be serialized at the first die after the packetizing (e.g., at step 1010). In specific embodiments, the second message may be serialized at the first die.

At step 1014, the message may be sent from the first die to the second die via an interconnect fabric link coupling the first die with the second die. The message may be sent after the serializing (e.g., at step 1012). In specific embodiments, the message, when sent from the first die to the second die, may have been compressed, by the compressing of the message, into a packet

In specific embodiments, and as part of sending the message, at step 1016, the second message may be sent from the first die to the second die. The message and the second message, when sent from the first die to the second die, may have been compressed, by the compressing of the message and the compressing of the second message, into a packet. The packet may have a size equal to a bandwidth of the interconnect fabric link.

At step 1018, the message may be deserialized at the second die. The message may be deserialized after the sending (e.g., at step 1014). In specific embodiments, the second message may be deserialized at the second die.

At step 1020, the message may be depacketized at the second die. The message may be depacketized after the deserializing (e.g., at step 1018). In specific embodiments, the second message may be depacketized at the second die.

At step 1022, the message may be decompressed at the second die. The message may be decompressed after the depacketizing (e.g., at step 1020).

In specific embodiments, at step 1024, the second message may be decompressed at the second die. The second message may be decompressed after the second message is sent (e.g., at step 1016).

Compressing and sending messages together in a single packet may improve effective bandwidth utilization by using existing physical layer software. Therefore, improved performance may be achieved without additional hardware and software costs. Additionally, compressing and sending the messages together may reduce the overhead compared to sending the messages separately, and may generally improve power consumption and performance without significant increase in die size or interconnect fabric size.

While the specification has been described in detail with respect to specific embodiments of the invention, it will be appreciated that those skilled in the art, upon attaining an understanding of the foregoing, may readily conceive of alterations to, variations of, and equivalents to these embodiments. Although examples in the disclosure were generally directed to inter-die communication, the same approaches could be used to increase bandwidth utilization percentages in other applications. These and other modifications and variations to the present invention may be practiced by those skilled in the art, without departing from the scope of the present invention, which is more particularly set forth in the appended claims.

What is claimed is:

1. A method comprising:
determining, at a first die, that a size of a message is smaller than or equal to a threshold;
compressing, at the first die, the message based on the determining; and
sending the message from the first die to a second die, the first die being physically separate from the second die and the first die sharing an interconnect fabric with the second die.

2. The method of claim 1, further comprising:
determining, at the first die, that a size of a second message is smaller than or equal to the threshold;
compressing, at the first die, the second message based on the determination that the size of the second message satisfies the threshold; and
sending the second message from the first die to the second die, wherein the message and the second message, when sent from the first die to the second die, are compressed by the compressing into a packet;
wherein the packet has a size equal to a bandwidth of an interconnect fabric link of the interconnect fabric.

3. The method of claim 2, wherein:
the size of the packet is set by a physical layer protocol of the interconnect fabric link.

4. The method of claim 1, wherein:
sending the message from the first die to the second die comprises sending the message via an interconnect fabric link having a bandwidth; and
the threshold is more than half of the bandwidth.

5. The method of claim 1, wherein:
sending the message from the first die to the second die comprises sending the message via an interconnect fabric link having a bandwidth; and
compressing the message comprises compressing the message to a compressed size that is equal to or less than half the bandwidth.

6. The method of claim 1, wherein the determining comprises:
decoding at least a portion of a header of the message to determine the size of the message.

7. The method of claim 1, further comprising:
determining, at the first die, that a size of a second message is smaller than or equal to a second threshold, the threshold being larger than the second threshold;
compressing, at the first die, the second message based on the determination that the size of the second message is smaller than or equal to the second threshold; and
sending the second message from the first die to the second die, wherein the message and the second message, when sent from the first die to the second die, are compressed by the compressing of the message and the compressing of the second message into a packet;
wherein the packet has a size equal to a bandwidth of an interconnect fabric link of the interconnect fabric, the message using more of the bandwidth than the second message.

8. The method of claim 1, further comprising:
packetizing, at the first die, the message after the compressing and before the sending;
depacketizing, at the second die, the message after the sending; and
decompressing, at the second die, the message after the depacketizing.

9. The method of claim 1, further comprising:
serializing, at the first die, the message after the compressing and before the sending;
deserializing, at the second die, the message after the sending; and
decompressing, at the second die, the message after the deserializing.

10. A system comprising:
a first die, the first die determining that a size of a first message is smaller than or equal to a first threshold and a size of a second message is smaller than or equal to a second threshold;
a compressing circuit, in the first die, that compresses, based on the determining, the first message and the second message into a packet;
an interconnect fabric link coupled to the first die and to a second die, the interconnect fabric link transporting the first message and the second message from the first die to the second die, the packet having a size equal to a bandwidth of the interconnect fabric link; and
a decompressing circuit, in the second die, that decompresses the first message and the second message.

11. The system of claim 10, wherein:
the size of the packet is set by a physical layer protocol of the interconnect fabric link.

12. The system of claim 10, wherein:
the first threshold is the same as the second threshold.

13. The system of claim 10, wherein:
the first threshold is more than half of the bandwidth of the interconnect fabric link; and
the second threshold is less than the first threshold.

14. The system of claim 10, wherein:
the compressing circuit compresses the first message to a first compressed size that is equal to or less than half the bandwidth of the interconnect fabric link; and
the compressing circuit compresses the second message to a second compressed size that is equal to or less than half the bandwidth of the interconnect fabric link.

15. The system of claim 10, wherein:
the compressing circuit compresses the first message to a first compressed size that is more than half the bandwidth of the interconnect fabric link; and
the compressing circuit compresses the second message to a second compressed size that is less than half the bandwidth of the interconnect fabric link.

16. The system of claim 10, wherein:
the first die decodes at least a portion of a header of the first message to determine the size of the first message.

17. The system of claim 10, wherein:
the first die packetizes the first message after compressing the first message and before the interconnect fabric link transports the first message; and
the second die depacketizes the first message after the interconnect fabric link transports the first message and before the second die decompresses the first message.

18. The system of claim 10, wherein:
the first die serializes the first message after compressing the first message and before the interconnect fabric link transports the first message; and
the second die deserializes the first message after the interconnect fabric link transports the first message and before the second die decompresses the first message.

19. A method comprising:
determining, at a first die, that a size of a message is equal to or less than a threshold size;
compressing, at the first die, the message based on the determination that the size of the message is equal to or less than the threshold size;
packetizing, at the first die and after the compressing, the message;
serializing, at the first die and after the packetizing, the message;
sending, after the serializing, the message from the first die to a second die via an interconnect fabric link, the interconnect fabric link coupling the first die with the second die;
deserializing, at the second die, the message;
depacketizing, at the second die and after the deserializing, the message; and
decompressing, at the second die and after the depacketizing, the message.

20. The method of claim 19, further comprising:
determining, at the first die, that a size of a second message is equal to or less than a second threshold size;
compressing, at the first die, the second message based on the determination that the size of the second message is equal to or less than the second threshold size;
sending the second message from the first die to the second die, wherein the message and the second message, when sent from the first die to the second die, have been compressed, by the compressing of the message and the compressing of the second message, into a packet; and
decompressing, at the second die, the second message;
wherein the packet has a size equal to a bandwidth of the interconnect fabric link.
